(19) United States
(12) Patent Application Publication
(10) Pub. No.: US 2019/0066878 A1
(43) Pub. Date: Feb. 28, 2019

(54) Energy Transmission Apparatus For A Vehicle

(71) Applicant: Siemens Aktiengesellschaft, Muenchen (DE)

(72) Inventor: Tabea Arndt, Erlangen (DE)

(73) Assignee: Siemens Aktiengesellschaft, Muenchen (DE)

(21) Appl. No.: 15/768,681

(22) PCT Filed: Sep. 28, 2016
(86) PCT No.: PCT/EP2016/073038

§ 371 Date: Apr. 16, 2018

(30) Foreign Application Priority Data
Oct. 19, 2015 (DE) 10 2015 220 301.8

(51) Int. Cl. H01B 12/16; B60R 16/03; H01F 6/06; H01B 12/02

(52) U.S. Cl. CPC H01B 12/16; B60R 16/03; B64D 27/24; H01B 12/02; H01F 6/06

(57) ABSTRACT

The present disclosure relates to vehicles. Various embodiments of the teachings thereof may include energy transmission apparatus for transmitting energy within a vehicle, in particular an aircraft. For example, an energy transmission apparatus may include: a superconducting cable run having a superconducting conductor element. The superconducting cable system transmits electrical energy with a power of at least 1 MW. The superconducting cable system has a weight per unit length of at most 2 kg/m.

### CROSS-REFERENCE TO RELATED APPLICATIONS

This application is a U.S. National Stage Application of International Application No. PCT/EP2016/073038 filed Sep. 28, 2016, which designates the United States of America, and claims priority to DE Application No. 10 2015 220 301.8 filed Oct. 19, 2015, the contents of which are hereby incorporated by reference in their entirety.

### TECHNICAL FIELD

The present disclosure relates to vehicles. Various embodiments of the teachings thereof may include energy transmission apparatus for transmitting energy within a vehicle, in particular an aircraft, having a cable system.

### BACKGROUND

In some vehicles, normal-conducting cables are employed for the transmission of electrical energy from a current source within the vehicle—for example, a battery, a fuel cell, or a generator—to an electrical load. In vehicles in general, and in aircraft in particular, it is important that the weight should be kept as low as possible, in order to restrict energy consumption for the transport of the tare weight of the vehicle. The electrical load can comprise, for example, one or more elements of the on-board electrics and/or electronics, or an electric motor for the propulsion of the vehicle, specifically a propeller motor, a fan motor, and/or a rotor motor. In an aircraft, a drive motor of this type often requires a supply with a high electric power rating. A corresponding energy transmission apparatus is therefore required to have capability for the transmission of electric power within a range of 1 MW to 20 MW between the at least one current source and the at least one load.

To permit current transmission at high power ratings of this type, a normal-conducting cable with copper conductors may be used. The useful voltage range for such cables in aircraft, on the grounds of ionization processes at high altitudes, and on the grounds of the steeply rising weight of the requisite cable insulation in proportion to the service voltage, is limited to values below the order of 2.5 kV. To achieve a transmission capacity of 500 kW, for example, three-phase alternating current can be transmitted at a service voltage of 1 kV and an overall current rating of 500 A. A three-phase transmission apparatus designed for this purpose, having three conductor runs, can reach a conductor weight of approximately 3.6 kg per meter, for example by the use of three commercially-available cables of the RHEYWIND LV-RS (N)HXCMFOE 0.6/1 kV type produced by the company Nexans.

In an aircraft, for the transmission of the requisite electric power for the drive motor, cable lengths of several tens of meters may be required, for example in the region of 50 m, or up to 100 m. Consequently, the application of a heavy cable of this type, the weight of which in the transmission apparatus is further compounded by the weight of the requisite connecting devices. Superconducting cables are generally appropriate for the achievement of a high current-carrying capacity with a low conductor cross-section, even at low voltages.

Typically, however, conventional superconducting cables are also heavy on the grounds that, in addition to the actual conductor elements, cryostat walls, thermal insulating elements, support elements, and dielectric insulating elements add to the overall weight. Commercially obtainable superconducting cables for transmission apparatuses of this type incorporate a double-walled cryostat, the respective walls of which are configured as corrugated tubes. A thermally-insulating vacuum jacket and, in many cases, an additional thermally-insulating shell are arranged between the two corrugated tubes. Cables of this type, based upon a high-temperature superconductor, are commercially obtainable, for example, from the company Nexans.

In the interior of the inner corrugated tube, a coolant duct is arranged, within which two or more layers of conductor runs are routed. Each layer typically comprises in excess of 10 individual conductors, for example of the order of 40 individual conductors per layer. The individual layers are arranged concentrically one around another, and are mutually separated by supporting materials and by solid-body dielectrics, to achieve the respective voltage withstand indicated. For example, high-temperature superconducting cables of this type are supplied for AC service voltages of 350 kV, or for DC service voltages of 650 kV. As a result of the complex structure described, such cables are no lighter, or not substantially lighter than known normal-conducting cables for the transmission of high electrical capacities.

### SUMMARY

The teachings of the present disclosure may be embodied in an energy transmission apparatus which overcomes the above-mentioned disadvantages. Specifically, some embodiments include an energy transmission apparatus which is particularly suitable for mobile applications in vehicles. For example, some embodiments may include an energy transmission apparatus (1) for transmitting energy within a vehicle, in particular an aircraft, having a cable system (3). The cable system (3) may include: at least one superconducting cable run (5) having at least one superconducting conductor element (7). The superconducting cable system (5) is designed for transmitting electrical energy with a power of at least 1 MW. The superconducting cable system (3) has a weight, which is related to its length (l), of at most 2 kg/m.

In some embodiments, a superconducting cable run (5) has a weight, related to its length (l), of at most 0.7 kg/m, and the cable system (3) has a weight, related to its length, of at most 1 kg/m. In some embodiments, the cable system (3) shows a current-carrying capacity of at least 500 A, and the cable system (3) is designed for operation at a transmission voltage (U_{T}) which lies below 10 kV.

In some embodiments, the cable system (3) comprises at least one double-walled cryostat (9) for the cooling of the superconducting conductor element (7), the cryostat walls (9a, 9b) of which, over a major proportion of the longitudinal extension (1) of the cable system (3), are configured as smooth-walled tubes.

In some embodiments, the cable system (3) is configured for the transmission of alternating current and, to this end, comprises a plurality of superconducting conductor elements (7), each of which is assigned to one phase of the alternating current.

In some embodiments, the conductors (7) for a plurality of phases are arranged within a common double-walled cryostat (9).

In some embodiments, each cable run (5) comprises only two, and at most six separate superconducting conductor elements (7), which are routed in pairs in an adjoining and mutually parallel arrangement.

In some embodiments, the at least one superconducting conductor element (7) is carried by one or more supporting elements (11) and/or is enclosed in one or more electrical insulating elements (13), wherein the overall weight of supporting elements (11) and insulating elements (13) in each cable run is at most 0.1 kg/m.

In some embodiments, the at least one superconducting conductor element (7) is arranged within a coolant duct (13) such that, during the operation of the apparatus, it can be surrounded by a stream of liquid coolant (15).

In some embodiments, the superconducting conductor element (7), at at least one end of the cable system (3), is connected to a superconducting coil winding (17).

In some embodiments, the superconducting coil winding (17) is a winding of a transformer (19) or a stator winding of a motor (23) or of a generator (21).

In some embodiments, there is a transformer (19) at either end of the cable system (3), for the transformation of the current generated by a current source (21) from an original voltage (U_{G}) into a lower voltage (U_{T}) for transmission in the cable system (3), and for the transformation of the current transmitted back to a higher voltage (U_{M}) required for the supply of a load (23).

As another example, some embodiments may include a vehicle, specifically an aircraft, having a current source (21), a load (23), and an energy transmission system (1) as claimed in one of the preceding claims for the transmission of electrical energy within the vehicle from the current source (21) to the load (23).

In some embodiments, the load (23) is an electric motor for the propulsion of the vehicle.

As another example, some embodiments may include a method for the transmission of energy in a vehicle, specifically an aircraft, characterized by the following steps: generation of electric current by means of a current source (21) arranged in the vehicle, and transmission of the electric current from the current source (21) to a load (23) by means of an energy transmission apparatus (1) as described above.

### BRIEF DESCRIPTION OF THE DRAWINGS

Individual exemplary embodiments are described hereinafter with reference to the attached drawings, in which:

FIG. 1 represents a superconducting cable run according to a first exemplary embodiment, in schematic cross-section;

FIG. 2 represents a superconducting cable run according to a second exemplary embodiment, in schematic cross-section;

FIG. 3 represents a superconducting cable run according to a third exemplary embodiment, in schematic cross-section;

FIG. 4 represents an energy transmission apparatus according to a third exemplary embodiment; and

FIG. 5 represents a superconducting cable run according to a fourth exemplary embodiment, in schematic longitudinal section.

### DETAILED DESCRIPTION

In some embodiments, an energy transmission apparatus for the transmission of energy within a vehicle, specifically an aircraft, has a cable system which comprises at least one superconducting cable run having at least one superconducting conductor element. In this case, the superconducting cable system is designed for transmitting electrical energy with a power of at least 1 MW. The superconducting cable system has a weight, which is related to its length, of at most 2 kg/m.

Here, and in general hereinafter, the above-mentioned length-related weight is understood to comprise the overall weight of the cable system (including any cable terminations fitted) divided by its overall length. Consequently, in comparatively short cable runs, the weight of such cable terminations which are employed, for example, to surmount a temperature difference between the cryogenic temperature and the warm ambient temperature is proportionally exceptionally high. The above-mentioned overall weight of the cable system also includes a fluid coolant which, for the operation of the cable system, is present in an interior coolant duct.

The transmission system thus comprises one or more superconducting cable runs which, in total, are sufficiently light that they can be employed in vehicles without contributing inordinately to the overall weight of the vehicle. Notwithstanding its relatively low weight, the superconducting conductor element can achieve a high current-carrying capacity, thereby permitting the transmission of electric power ratings of at least 1 MW, for example for a drive motor of the vehicle. Some embodiments include the transmission of this power at a comparatively high current, and the exploitation of the high current-carrying capacity of the superconducting conductor element.

The cable system does not then need to be designed for a very high voltage range, but can be designed for low high-end voltages, for example in the region of a maximum 10 kV, thereby reducing the stringency of requirements for dielectric insulation, and thus the weight of a cable run. The complexity of the cable system, in comparison with conventional superconducting cable systems, can thus be reduced, thereby permitting the achievement of a low cable weight. The electrical insulation of the cable can therefore be configured with sufficient lightness, such that the indicated overall weight of the cable system is not exceeded. In comparison with normal-conducting cable systems, by means of superconducting properties, the cross-section of the actual conductor element can be significantly reduced, thus, in turn, permitting a lower cable weight.

In some embodiments, a vehicle, specifically an aircraft, comprises a current source, a load and an energy transmission system as described above for transmitting electrical energy within the vehicle from the current source to the load. The method for transmission of the energy in a vehicle, specifically in an aircraft, comprises the following steps: generation of electric current by means of a current source arranged in the vehicle, and transmission of the electric current from the current source to a load by means of an energy transmission apparatus.

Advantageous configurations and further developments proceed from the following description. The configurations of the energy transmission apparatus, the vehicle, and the method described herein can be mutually combined. The at least one superconducting cable run can have a weight, related to its length, of at most 0.7 kg/m. In some embodiments, this weight per cable run can be at most 0.3 kg/m, and specifically at most 0.15 kg/m. Conversely to the above-mentioned overall weight of the cable system, the weight of a cable run, related to its length, does not include any cable terminations fitted. In general, the overall weight of the overall cable system (including any cable terminations), related to its length, can be at most 1 kg/m, and at most 0.5 kg/m. The cable system can also comprise a plurality of cable runs, for example three cable runs for the transmission of three-phase alternating current.

In some embodiments, the cable system can generally show a current-carrying capacity of at least 500 A, a current-carrying capacity of at least 1000 A, and specifically even of at least 3000 A. Specifically, in a cable system comprising a plurality of cable runs, each individual cable run can show a current-carrying capacity of this magnitude. A high current-carrying capacity of this type permits the transmission of a high electric power rating of at least 1 MW at a comparatively low voltage, of the order of a few kV.

For example, the cable system can be designed for operation at a voltage which lies below 10 kV. For example, such a service voltage of the cable system can lie between 0.5 kV and 5 kV. The cable run or cable runs in a cable system thus configured can then be of a correspondingly lightweight design, as the at least one superconducting conductor element does not require protection against flashover at very high voltages, and the electrical insulation of the cable can be of a correspondingly thin and lightweight design. It can thus be that the weight of the electrical insulation lies sufficiently below the indicated overall weight, such that the indicated values for the overall weight of the cable system per unit of length are not exceeded.

In some embodiments, the cable system comprises at least one double-walled cryostat for the cooling of the superconducting conductor element to a temperature below its critical temperature. Between the two walls of the cryostat, a vacuum can thermally insulate the interior of the cryostat from the external environment. Additionally, the cryostat, for example between the two walls or adjacently to the interior and/or exterior thereof, can incorporate at least one further thermal insulating element.

Cable systems comprising a plurality of cable runs can incorporate a common cryostat, within which a plurality of cable runs are routed. The weight of such a cable system, comprised of a plurality of cable runs, can thus be restricted to a particularly low value. In some embodiments, it is also possible, in principle, for each cable run to be enclosed in a dedicated cryostat.

In some embodiments, the cryostat walls of the double-walled cryostat, over a major proportion of the longitudinal extension of the cable system, can be configured as smooth-walled tubes. In applications requiring a high degree of mechanical flexibility in the cable system, the smooth-walled double tube structure of such a cryostat can also be interrupted by one or more segments of corrugated design. The corresponding segments, configured with a double corrugated tube structure, in a similar manner to the prior art, can be employed in the interests of mechanical deformability.

For the achievement of a low cable weight, it is sufficient that the cryostat, over a predominant proportion of the cable length, is configured as a smooth-walled cryostat. The low-friction conveyance of a coolant fluid carried in the interior of the cryostat is then possible, thus additionally reducing the weight of a pump system for the cooling circuit. Flashover between the conductor element and the cryostat wall can be reduced by a smooth configuration of the cryostat wall, without the necessity for heavy dielectric insulating elements between the conductor element and the cryostat wall.

In general, the proportion by weight of the double-walled cryostat in the weight of the cable system can lie below 0.25 kg/m, and specifically below 0.1 kg/m. The cryostat walls can be configured of a metallic material, or can at least incorporate a metallic material. In some embodiments, the cryostat walls can also be configured of a plastic material, or can incorporate such a material. For example, the plastic may comprise a polyether ether ketone (PEEK).

In some embodiments, the at least one superconducting conductor element may comprise a high-temperature superconducting conductor material. High-temperature superconductors (HTS) are superconducting materials having a critical temperature in excess of 25 K and, in the case of some material classes, for example cuprate superconductors, in excess of 77 K, wherein the service temperature can be achieved by cooling with cryogenic materials other than liquid helium. HTS materials are therefore particularly attractive, as these materials, depending upon the service temperature selected, can show very high critical current densities, and are thus appropriate for cable systems with very high current-carrying capacities.

In some embodiments, the high-temperature superconducting material may comprise magnesium diboride. In some embodiments, the conductor element may comprise magnesium diboride as its main constituent, or can even be primarily constituted of magnesium diboride. Magnesium diboride has a critical temperature of approximately 39 K, and thus qualifies as a high-temperature superconductor, although this critical temperature is somewhat low, in comparison with other HTS materials. The advantages of this material, in comparison with ceramic oxide high-temperature superconductors, are associated with its ease of production, and consequently the cost-effectiveness of the latter. Magnesium diboride-based conductors can be produced in a particularly simple and cost-effective manner by aerosol deposition, or by the “powder-in-tube” method.

In some embodiments, however, the conductor element may comprise other high-temperature superconducting materials, for example second generation HTS materials, e.g. compounds of the REBa₂Cu₃Oₓ type (abbreviated to “REBCO”), wherein “RE” stands for a rare earth element, or a mixture of such elements. As a result of their high critical temperatures, REBCO superconductors can also be cooled by liquid nitrogen and, particularly at lower temperatures than 77 K, show a particularly high current-carrying capacity.

Other potential materials include first generation HTS materials, for example, different variants of bismuth-strontium-calcium-copper oxide. In some embodiments, superconducting pnictides can also be employed. As a result of their rather low critical temperature, superconducting pnictides can be considered for a service temperature of the order of 20 to 30 K.

The cable system can be configured for the transmission of alternating current. To this end, the cable system comprises a plurality of superconducting conductor elements, each of which is assigned to one phase of the alternating current. Specifically, this can involve a cable for the transmission of three-phase alternating current. The conductor elements which are assigned to the respective phases can advantageously be routed in individual cable runs. For example, an individual cable run can be provided for each phase, which can respectively comprise two electrically-separated conductors. The cable runs of the individual phases, as described above, can either be advantageously arranged in a common cryostat or, alternatively, can be arranged in separate cryostats.

In some embodiments, however, the cable system may be configured as a cable system for DC transmission. Again, in this form of embodiment, by means of superconducting conductor elements, the transmission of high electric power can be achieved with a low overall weight of the cable system. For DC transmission, as few as two electrically-separated superconducting conductors are required. Correspondingly, an even smaller mass per meter of the cable system needs to be employed for insulating elements, and the cable system can be configured as a DC cable system of exceptionally lightweight design.

In general, each cable run may comprise only a maximum of two separate superconducting conductor elements, which are routed in an adjoining and mutually parallel arrangement. In this case, conversely to the prior art—for example, cables produced by Nexans—each conductor layer is not comprised of a plurality of separate conductor runs or filaments, but each electrical conductor unit is constituted of one conductor element only. This conductor element can be, for example, a superconducting wire, a superconducting strip conductor or another type of superconducting layer, arranged on a substrate. It is essential that the respective conductor element is not comprised of a plurality of individual conductor runs or a stranded conductor bundle, but comprises only a single superconducting body, such that the complexity of the cable structure is significantly reduced. In this manner, a cable system of significantly simpler and lighter construction can be achieved.

In some embodiments, each electrically-separated conductor unit is not constituted by a single conductor element, but only by a small number thereof. For example, between two and four conductor elements can be provided per electrically-separated conductor unit. In comparison with only one conductor element per electrical conductor unit, a greater redundancy can thus be achieved, whereby a simple and consequently easily-executed cable system is nevertheless still provided.

Regardless of whether each cable run comprises only two separate conductor elements as individual conductors or, as described above, a somewhat larger number of up to four conductor runs per conductor unit, the two conductor units in a cable run can be routed in an adjacent and mutually parallel arrangement. In a distinction from the prior art, in which the individual conductor units are typically arranged coaxially, one inside another, a design of this type can be configured in a substantially simpler manner, with a smaller number and/or mass of mechanical supporting elements and/or of electrical insulating elements. A cable run of this type can thus be configured with a lower weight per meter than a conventional cable run with coaxially-configured conductor units.

In some embodiments, the at least one superconducting conductor element can be carried by one or more supporting elements and/or can be enclosed in one or more electrical insulating elements. The overall weight of supporting elements and insulating elements in each cable run of the cable system may be at most 0.1 kg/m, at most 0.05 kg/m, or even at most 0.03 kg/m. In turn, each cable run can again be assigned to one phase of an alternating current transmission system. In some embodiments, even the full weight of supporting and insulating elements in the entire cable system lies within the indicated ranges of values. By means of a low weight of this type for insulating and support elements, the indicated maximum values for the overall weight per meter of the cable run and/or for the overall weight per meter of the cable system can be achieved in a particularly simple manner.

In the operation of the cable system, the at least one superconducting conductor element can be cooled by a fluid coolant. To this end, a coolant duct can be arranged in the interior of the cable system, specifically in the interior of a cryostat in the cable system, in which, for example, liquid nitrogen, liquid hydrogen or liquid helium can flow. In some embodiments, the at least one superconducting conductor element can be arranged within a coolant duct such that, during the operation of the energy transmission apparatus, it can be surrounded by a stream of liquid coolant. The coolant, in addition to cooling, can also assume the function of dielectric insulation, thereby reducing the weight associated with solid-body dielectrics. Liquid coolants such as liquid nitrogen, liquid hydrogen or liquid helium show a voltage withstand of the order of 50 kV/mm. If the at least one, and all the superconducting conductor elements are radially surrounded on all sides by coolant, an additional solid-body insulator can either be omitted altogether, or can be reduced to a minimum. For example, the at least one conductor element, considered radially in all directions, can be enclosed in at least one liquid coolant jacket to a thickness of 1 to 2 mm. Although this liquid jacket can be essentially continuous, the interruption thereof by individual supporting elements, for example supporting struts for the mechanical retention of the at least one conductor element in the interior thereof, is not excluded.

In some embodiments, the cable run can generally assume a circular external cross-section. In some embodiments, however, it can assume an external cross-sectional shape which deviates from this geometry. For example, by means of a square cross-section, a lower weight of coolant enclosed in the coolant duct can be achieved, while simultaneously maintaining a stipulated minimum thickness of a liquid jacket which surrounds the respective conductor elements, for example to a minimum value of 1 mm on all sides.

Liquid hydrogen may be used as a coolant, on the grounds that, of the fluids mentioned, it has a particularly low specific mass, and thus makes a low contribution to the overall weight of the respective cable run. Thus, even in the case of cable diameters of several centimeters, the weight contribution of the coolant can be maintained below 100 g/m and, in some cases, even below 50 g/m. For example, in the case of a cable diameter of 2.5 cm, the weight contribution of the liquid hydrogen employed as a coolant can be of the order of 35 g/m.

The liquid coolant conveyed in the coolant duct of the cable system can form a closed circuit, within which the coolant is circulated for re-use, for example by means of a pump. To this end, a plurality of coolant ducts can be arranged within the same, or within different cable runs, to circulate the coolant along the cable system and back again.

In some embodiments, however, the coolant can be conveyed in one direction along the cable system only. This is particularly appropriate if the coolant is liquid hydrogen which, at the end of the cable system to which it flows, is employed for the generation of energy.

In some embodiments, the at least one superconducting conductor element can be electrically insulated by the enclosure thereof in a solid-body dielectric. For example, the conductor element, and each conductor element present, can be enclosed in an electrically-insulating polymer such as, for example, extruded polyether ether ketone (PEEK). An enclosure of this type can be configured with a limited film thickness, thus making a correspondingly small contribution to the weight of the cable system. For example, the film thickness can lie below 2 mm, and specifically below 1 mm.

At at least one end of the cable system, the superconducting conductor element can be connected to a superconducting coil winding. Specifically, with no interruption in the environment thereof which can be cooled to a cryogenic temperature, the superconducting conductor element can be connected to such a superconducting coil winding. The superconducting coil winding can likewise either form part of the energy transmission apparatus or, alternatively, can be an additional electrical device, which is also arranged in the vehicle.

In some embodiments, the cable system, at the end thereof at which the superconducting coil winding is arranged, is not fitted with a cable termination, by means of which an electrical connection between the cryogenically-cooled superconductor and a warm external conductor is provided. Rather, the corresponding end of the cable is provided with a contact element for connection with the superconducting coil winding which, in common with the superconducting conductor element and the superconducting coil winding, can be cooled to a cryogenic temperature. In the operation of the energy transmission apparatus, the at least one superconducting conductor element, the superconducting coil winding and the intervening electrical contact thus lie within a continuous cryogenic temperature range, with no intervening electrical connecting element within the temperature range of the comparatively warm ambient temperature of the vehicle.

This continuously cryogenic electrical connection of the conductor element of the cable system to the conductor of the coil winding provides that, on this side, the weight of a complex cable termination for the connection of cold and warm conductors is saved. Overall, the energy transmission apparatus can thus be lighter in its construction. Secondly, by means of the continuously cold electrical connection, electrical losses are reduced. In some embodiments, the connection between the conductor element of the cable system and the superconducting coil winding can even be continuously superconducting. However, this is not absolutely necessary to the realization of a weight-saving advantage. If the superconducting conductor element, at both ends of the cable system, is connected to a superconducting coil winding in the manner described and/or if all the conductor elements in the cable system are connected to one or more superconducting coil windings.

In some embodiments, the superconducting coil winding can be a winding of a transformer, or a stator or rotor winding of a motor or a generator.

Embodiments with a superconducting transformer winding is particularly appropriate, if the transmission apparatus is an apparatus for the transmission of alternating current. Two such superconducting transformer windings can then be provided—one at either end of the cable system—for the transformation of the current to be transmitted after the current source into a voltage which is appropriate for transmission, and thereafter for the further transformation thereof into a voltage which is appropriate for the load. In this form of embodiment, the transformers are also elements of the energy transmission apparatus.

In some embodiments, one end of the cable system can be connected to a winding of a motor or a generator. It is also possible for one end to be connected to a winding of a generator, and the other end to be connected to a winding of a motor. The generator can be an element of a current source arranged in the vehicle and/or the motor can be an element of a drive system arranged in the vehicle. In some embodiments, the entire electrical chain between the current source, the transmission system and the load can be of a continuously cold and, specifically, even of a continuously superconducting design. In principle, this configuration can apply to both direct current and alternating current transmission systems. The weight of the transmission system can be kept low, as complex connecting elements for the connection of warm and cold conductor elements can be omitted. Moreover, overall electrical and thermal losses are reduced. In direct current transmission systems, a continuously superconducting transmission chain provides as, in this case, no galvanic separation in the form of transformers and/or converters is required.

In general, the energy transmission apparatus may include a transformer at either end of the cable system, for the transformation of the current generated by a current source into a lower voltage for transmission in the cable system, and for the transformation of the current transmitted back to a higher voltage required for the supply of a load. The transformers may incorporate superconducting coil windings. If this is the case, the windings of the two transformers and the cable system can constitute a continuous environment which is coolable to a cryogenic temperature. Specifically, a cryostat in the cable system can be continuously connected to the cryostats of the superconducting transformers. A commonly-coolable interior space can be provided in a common coolant circuit constituted by these three components.

In general, the transformation of the alternating current to be transmitted into a lower transmission voltage permits the transmission of electrical energy in a cable system of lower weight. A high voltage of several tens of kV or more can thus be transformed into a significantly lower voltage, in a range below 10 kV. Only a higher current must then be transmitted, which is easily achievable by means of a superconducting conductor element. Additionally, the superconducting cable system does not need to be rated for very high voltages, and the at least one cable run, on the grounds of the moderate requirements for the voltage withstand thereof, can be configured with a correspondingly lightweight design.

By means of superconducting transformer windings, transformation into a favorable voltage for transmission can be achieved in a particularly simple manner, without the requirement for substantial additional weight in the transformers. In some embodiments, a transformer with one or more superconducting windings can be configured with no soft magnetic core in the predominant proportion of the winding, such that the weight thereof can be substantially lower than that of transformers having such cores.

In a multi-phase transformer, a plurality of superconducting windings can be provided, wherein each pair of windings is respectively assigned to one phase. These windings can be arranged within a common cryostat, thereby likewise contributing to a saving of space and weight. In general, the individual superconducting windings of the transformer can be configured as annular windings, each having an annular opening and an axial offset in the region of the opening. By means of these openings, a stipulated magnetic coupling of the individual phases may be achieved.

In some embodiments, on the side of the current source and/or on the side of the load, an additional converter can be arranged to alter the frequency of the alternating current to be transmitted, or of the alternating current transmitted. Such a converter can be arranged, for example, between the current source and the first transformer, or between the second transformer and the load. Such converters can be considered as elements of the transmission apparatus.

The vehicle having the energy transmission apparatus described can be an aircraft, specifically an airplane or a helicopter. In principle, however, the vehicle can also be of a different type, for example, a land vehicle, water vehicle or space vehicle, e.g., a vehicle in which a requirement for an electric transmission apparatus of low weight applies. In some embodiments, the above-mentioned load in the vehicle can be an electric motor for the propulsion of the vehicle. The vehicle can thus be a vehicle with an electric and/or hybrid electric drive. Specifically, the motor can be a propeller motor, a fan motor and/or a rotor motor of the electrically-driven vehicle.

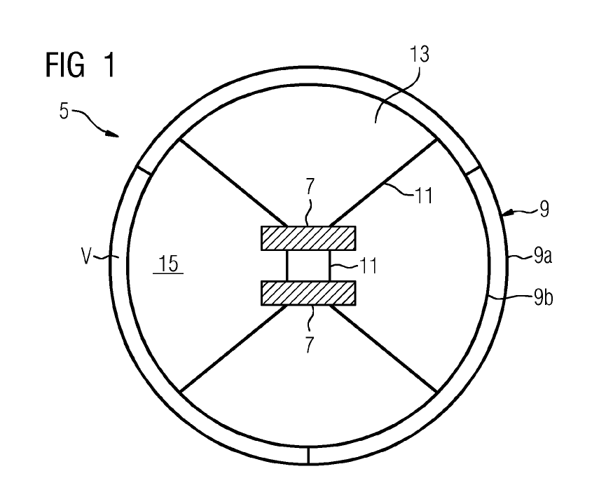

FIG. 1 shows a schematic cross-section of a superconducting cable run 5 according to a first exemplary embodiment. Two superconducting conductor elements 7, each of which comprises only a single conductor run and is not subdivided into further sub-conductors, are shown. These two conductor elements 7 are routed in a mutually adjacent and parallel arrangement in the interior of the cable run 5. They are enclosed in a double-walled cryostat 9, wherein the interspace between the outer cryostat wall 9a and the inner cryostat wall 9b is evacuated.

The function of the vacuum V is to thermally insulate the interior region of the cryostat from the warm external environment, thereby maintaining the superconducting conductor elements 7 at a cryogenic service temperature which lies below the critical temperature of the respective superconducting material. To permit the effective execution of the corresponding cooling, a coolant duct 13 is configured in the interior of the cryostat 9, within which a fluid coolant 15 can flow. The coolant thus flows around the two conductor elements 7, thereby effectively cooling the latter.

For the electrical insulation of the two conductor elements 7, both mutually and vis-à-vis the inner wall 9b of the cryostat 9, a stipulated clearance is maintained between the latter by means of supporting elements 11 in an interior region of the coolant duct 13. A minimum clearance is thus maintained between the latter, both mutually and vis-à-vis the inner cryostat wall 9a which, for example, can be at least 1 mm. The coolant 15 flowing in the coolant duct 13 thus functions as a dielectric, and electrically insulates the conductor elements 7, specifically for the prevention of flashover. If, as represented in FIG. 1, this electrical insulation is only provided by the coolant 15, and not by a further solid-body dielectric, the cable run can be configured with an exceptionally low cable weight per unit of cable length. As a general alternative, however, the conductor elements 7 can also be enclosed in an additional solid-body insulator, which is not represented here.

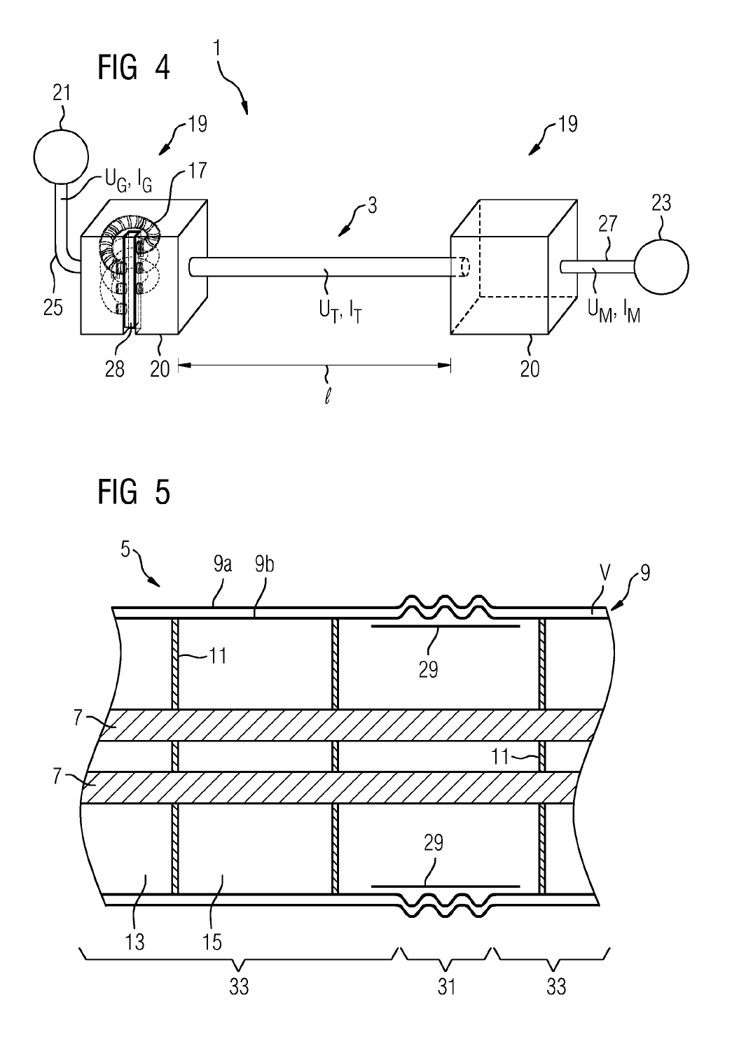

A key feature of the example represented in FIG. 1 is that, by means of the simple configuration of the cable run 5, a very low overall weight of the cable run 5 can be achieved. This cable run 5 can be employed in a cable system 3 for the realization of an energy transmission apparatus 1, as described hereinafter with reference to the example in FIG. 4. The cable run 5 according to the first exemplary embodiment can specifically constitute a single run in the cable system 3 of the transmission apparatus 1. For example, a single cable run of this type can be employed for direct current transmission. In some embodiments, a plurality of such cable runs can be employed for the resulting constitution of a cable system 3. For example, a plurality of cable runs can be routed in a mutually parallel arrangement, as elements of such a cable system. Accordingly, a three-phase alternating current can be transmitted by means of three such cable runs 5.

Hereinafter, exemplary materials and dimensions are indicated, in order to clarify how the cable run 5 represented in FIG. 1 can be executed with a sufficiently low weight. In the example illustrated, the external diameter of the cable run 5 should be of the order of 2.5 cm, with a clearance of 1 mm between the inner cryostat wall 9b and the outer cryostat wall. The two cryostat walls can have a respective thickness of approximately 0.2 mm. The resulting weight contribution of cryostat walls of stainless steel construction is of the order of 250 g/m, and the weight contribution of cryostat walls of PEEK construction is only of the order of 41 g/m, for both walls 9a and 9b combined.

From this example, it is clear that the weight contribution of the cryostat walls is a significant factor. In some embodiments, aluminum is used for the cryostat walls, for the achievement of a weight reduction in comparison with stainless steel. For the dimensions indicated, the resulting weight contribution of aluminum cryostat walls is 84 g/m.

The weight contribution of the two conductor elements, given a conductor width of 10 mm and a conductor thickness of 0.2 mm, and assuming an average density of the order of 8 g/cm³, is approximately 32 g/m for both conductor elements 7 combined. The values indicated are based upon typical dimensions and densities for strip conductors with high-temperature superconducting layers of the second generation, based upon a strip metal substrate.

In addition to the thickness and material composition of the individual elements, the weight contribution of the supporting elements 11 is dependent upon the axial spacing thereof, i.e. the number of elements per meter of cable. In the example indicated, the weight contribution of the supporting elements 11 will lie below 30 g/m, and is thus lower than that of the conductor elements 7. The supporting elements may comprise plastic, or can at least incorporate plastic as a material.

For the dimensions specified, the weight contribution of the coolant 15 flowing in the interior of the coolant duct 13 is of the order of 380 g/m, in the case of liquid nitrogen, and of the order of only 34 g/m, in the case of liquid hydrogen.

Depending upon the selected combination of the exemplary materials specified, the overall weight of the cable run 5 relative to its length (excluding any contribution of cable terminations) can thus range from approximately 137 g/m (for PEEK cryostat walls and liquid hydrogen) to 692 g/m (for stainless steel cryostat walls and liquid nitrogen).

Naturally, the dimensions indicated are to be understood as exemplary only, and the weight contributions of the individual components can be scaled in a known manner, according to the diameter of the cable run 5 and of the coolant duct 15, the wall thicknesses of the cryostat walls 9a, 9b, and the dimensions of the conductor elements 7, and according to the densities of the materials employed. Specifically, the external diameter of the cable run 5 can be either higher or lower than in the example indicated here. This is only intended to illustrate, in an exemplary manner, how the employment of selected materials and the omission of a high proportion by volume of a solid-body dielectric can permit an exceptionally lightweight cable run 5.

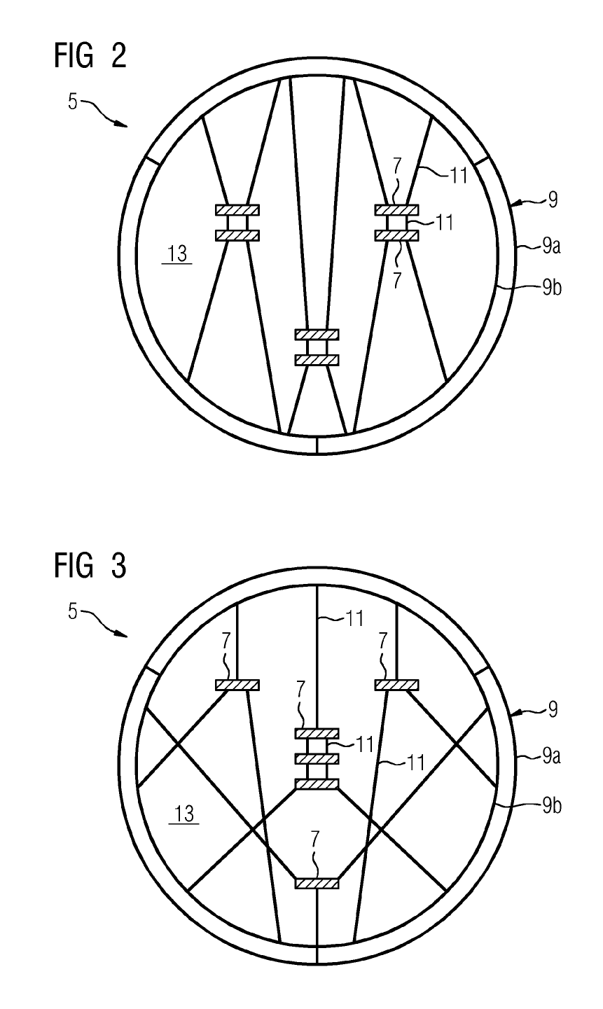

FIG. 2 represents a schematic cross-section of a superconducting cable run 5 according to a second exemplary embodiment. A cable run 5 is represented for the transmission of three-phase alternating current, comprising a total of six superconducting conductor elements 7, respectively arranged in adjoining pairs. Each pair thus comprises one phase conductor and one return conductor respectively. The two conductors in a given pair are braced against each other by means of comparatively short supporting elements 11, whereas each overall pair is braced against the inner wall 9b of the common cryostat which encloses all the conductor elements 7 by means of longer supporting elements 11. In the interior space of the cryostat, a coolant duct 13 is configured, within which a coolant fluid can flow around the conductor elements 7 and the supporting elements 11.

FIG. 3 represents a schematic cross-section of an alternative superconducting cable run 5, which is likewise designed for the transmission of three-phase alternating current. Here again, a total of six superconducting conductor elements 7 are arranged within a common cryostat 9. In this example, three conductor elements 7 functioning as return conductors are arranged in a parallel-routed bundle in the center of the internal cavity, wherein these individual return conductors, in turn, are mutually braced by short supporting elements 11, and are braced against the inner cryostat wall 9b by means of longer supporting elements 11. Conversely, the three phase conductors 7 are arranged individually in radially further outlying regions of the coolant duct 13 and are each individually braced against the inner cryostat wall 9b by means of a plurality of supporting elements 11. Overall, this arrangement produces a more complex network of supporting elements. However, the intersection of various supporting elements 11 shown in the schematic cross-sectional representation is not problematic in reality, as these can be arranged in different positions in the axial direction of the cable run 5 and, in consequence, are not actually located in an overlapping position.

Otherwise, specifically with respect to the clearances of the conductor elements 7, both mutually and to the cryostat wall, the coolant and the optional provision of an additional solid-body insulator around the conductor elements, the cable runs 5 in the second and third exemplary embodiments can be configured analogously to the cable run in the first exemplary embodiment.

FIG. 4 shows a schematic perspective representation of an energy transmission apparatus 1 according to a fourth exemplary embodiment. The energy transmission apparatus 1 is configured for the transmission of three-phase alternating current. To this end, it incorporates a cable system 3 which, for example, can comprise three cable runs according to the exemplary embodiment in FIG. 1, or according to the exemplary embodiment in FIG. 2. By means of this cable system 3, electrical energy which is generated by a generator 21 is transmitted to a motor 23. The transmission system 1, together with the generator 21 and the motor 23, are arranged on a mobile vehicle, which is not represented in greater detail here.

The function of the generator 21 is thus the generation of three-phase alternating current at a generator voltage U_{G} and a generator current rating I_{G}. For example, U_{G} can be of the order of 33 kV, and I_{G} can be of the order of 30 A. These values for current and voltage can lie within the same range as the values for current I_{M} and voltage U_{M} required by the motor 23 of the vehicle. In this case, however, for the purposes of transmission by means of the energy transmission apparatus 1, the input current is stepped-down to a lower transmission voltage U_{T} by means of a transformer 19.

Further to transmission, the current is stepped-up again by means of a further transformer 19. The two transformers 19 represented respectively constitute elements of the transmission apparatus 1. For example, the transmission voltage U_{T} can be of the order of 1 kV, and the transmission current I_{T} can be of the order of 1 kA. Thus, electric power in the region of 1 MW can be transmitted. The at least one superconducting conductor element 7 of the cable system 3 is employed to achieve the requisite high current-carrying capacity for the comparatively high transmission current I_{A}. As the transmission voltage U_{T} is comparatively low, the dielectric insulation of the cable run or cable runs can be configured to a relatively lightweight and thus space-saving design, such that the overall weight of the cable system 3 (inclusive of the coolant 15 contained therein) can be restricted to a low value, according to the invention.

The two transformers 19 represented in FIG. 4 can respectively be equipped with superconducting transformer windings 17. To maintain these superconducting transformer windings 17 at a cryogenic service temperature, these windings 17 can be arranged in a transformer housing 20 which is configured as a cryostat. Accordingly, the total of six windings required for the transformation of three-phase alternating current can be arranged within a common housing 20, as illustrated in FIG. 4. The three phases can thus be magnetically coupled by means of a soft magnetic coupling yoke 28 in the end regions of the windings 17.

The superconducting form of the transformers 19, in conjunction with the present disclosure, provides that the cryostats 20 of the transformers 19, in combination with the at least one cryostat 9 of the cable system 5, can constitute a common and continuously cold environment in the interior thereof. These three cryostats 20, as indicated in FIG. 4, can thus be connected over the entire length 1 of the cable system 5 to form a continuously cold system. Thus, for the transitions between the superconducting conductor elements 7 of the cable system 3 and the coil windings 17 of the transformers 19, specifically, no bushings between a cold and a warm environment are required in the end region of the cable system 3. The weight associated with the correspondingly configured cable terminations for the accommodation of such a temperature difference required in conventional cable systems is saved accordingly.

In the example represented in FIG. 4, the generator 21 and the motor 23 are each connected by means of a further connection system 25 or 27 to their respectively associated transformer 19. These further connection systems 25 and 27 are preferably configured with a very short length in comparison with the cable system 3, and thus make only a small contribution to the weight of the vehicle. In this case, current can also be transmitted to a warm environment by means of normal-conducting cables, particularly where the generator and the motor incorporate normal-conducting windings. The transformers, on the respective side thereof which is averted from the cable system 3, can then incorporate bushings for the connection of the cold windings 17 to the warm connection system 25 or 27.

In some embodiments, however, the generator 21 and/or motor 23 can also incorporate one or more superconducting stator windings. The generator side or motor side of the transformers can then be connected by means of continuous superconducting conductors to the corresponding superconducting stator windings in a continuous cold environment. The necessary weight which is typically associated with bushings between a cold and a warm environment can be saved accordingly, and both electrical and thermal losses can also be reduced.

FIG. 5 shows a schematic longitudinal section of a superconducting cable run 5 according to a fifth exemplary embodiment. In cross-section, for example, the cable can be of similar design to that of the example represented in FIG. 1. Over the major part of the length 1 of the cable run, the double-walled cryostat 9 is configured with smooth, i.e. non-corrugated cryostat walls 9a and 9b. In the section represented, these are the segments 33. In the section represented, a corrugated segment 31 is arranged between the latter. In corrugated segments 31 of this type, the vacuum-insulated shell assumes a corrugated profile, thereby increasing the mechanical flexibility of the conductor in response to expansion and compression, and in response to bending in this region. Notwithstanding, to achieve the lowest possible current resistance and the lowest possible turbulence of the coolant 15 flowing in the coolant duct 13, the inner cryostat wall 9b in these segments can be lined with a smooth-walled pipe insert 29.

What is claimed is:

1. An energy transmission apparatus for transmitting energy within a vehicle having a cable system, the apparatus comprising:
a superconducting cable run having a superconducting conductor element;
wherein the cable system transmits electrical energy with a power of at least 1 MW; and
the cable system has a weight per unit length of at most 2 kg/m.

2. The energy transmission apparatus as claimed in claim 1, wherein the superconducting cable run has a weight per unit length of at most 0.7 kg/m; and
the cable system has a weight per unit length of at most 1 kg/m.

3. The energy transmission apparatus as claimed in claim 1,
wherein the cable system has a current-carrying capacity of at least 500 A; and
the cable system operates at a transmission voltage below 10 kV.

4. The energy transmission apparatus as claimed in claim 1, wherein the cable system comprises a double-walled cryostat for the cooling of the superconducting conductor element,
wherein both cryostat walls, over a major proportion of a longitudinal extension of the cable system comprise smooth-walled tubes.

5. The energy transmission apparatus as claimed in claim 1, wherein the cable system is configured for the transmission of alternating current and comprises a plurality of superconducting conductor elements, each of which is assigned to one phase of the alternating current.

6. The energy transmission apparatus as claimed in claim 5, wherein the conductor elements for a plurality of phases are arranged within a common double-walled cryostat.

7. The energy transmission apparatus as claimed in claim 1, wherein each cable run comprises at least two and at most six separate superconducting conductor elements routed in pairs in an adjoining and mutually parallel arrangement.

8. The energy transmission apparatus as claimed in claim 1, wherein the superconducting conductor element is carried by a supporting element and/or is enclosed in one or more electrical insulating elements,
wherein the overall weight of supporting elements and insulating elements in each cable run is at most 0.1 kg/m.

9. The energy transmission apparatus as claimed in claim 1, wherein the superconducting conductor element is arranged within a coolant duct such that, during the operation, it can be surrounded by a stream of liquid coolant.

10. The energy transmission apparatus as claimed in claim 1, wherein an end of the superconducting conductor element is connected to a superconducting coil winding.

11. The energy transmission apparatus as claimed in claim 10, wherein the superconducting coil winding comprises a winding of a transformer or a stator winding of a motor or of a generator.

12. The energy transmission apparatus as claimed in claim 1, further comprising a transformer at each end of the cable system, for the transformation of the current generated by a current source from an original voltage (U_{G}) into a lower voltage (U_{T}) for transmission in the cable system, and for the transformation of the current transmitted back to a higher voltage (U_{M}) required for the supply of a load.

13. A vehicle comprising:
a current source;
a load; and
a superconducting cable run having a superconducting conductor element;
wherein the cable system transmits electrical energy with a power of at least 1 MW; and
the cable system has a weight per unit length of at most 2 kg/m;
wherein the superconducting cable transmits electrical energy within the vehicle from the current source to the load.

14. The vehicle as claimed in claim 13, wherein the load comprises an electric motor for the propulsion of the vehicle.

15. A method for the transmission of energy in a vehicle, the method comprising
generating an electric current with a current source arranged in the vehicle; and
transmitting the electric current from the current source to a load with a superconducting cable run having a superconducting conductor element;
wherein the cable system transmits electrical energy with a power of at least 1 MW; and
the cable system has a weight per unit length of at most 2 kg/m.
